(19) United States
(12) Patent Application Publication
(10) Pub. No.: US 2020/0066191 A1
(43) Pub. Date: Feb. 27, 2020

(54) Weather-Resistant, Crush-Resistant Lighted Panel for Roadways, Driveways or Walkways

(71) Applicant: EVOLUTIONARY MARKINGS, INC., Boise, ID (US)

(72) Inventors: Charles L. King, Boise, ID (US); Thomas R. Linville, Boise, ID (US); Douglas L. Baker, Boise, ID (US)

(21) Appl. No.: 16/460,815

(22) Filed: Jul. 2, 2019

Related U.S. Application Data
(60) Provisional application No. 62/693,430, filed on Jul. 2, 2018.

(51) Int. Cl. G09F 7/00; G09F 19/22; G09F 13/00

(52) U.S. Cl. CPC G09F 7/002; H04M 2250/02; G09F 13/005; G09F 19/22

(57) ABSTRACT

Disclosed is a weather-resistant and crush-resistant display panel for placement on or in the surface of roadways, driveways, walkways, patios, or other locations and substrates. The panel is sealed within a polycarbonate enclosure with installed electro (electric/electronic) components that are protected by the set-up polycarbonate which cooperates with the enclosure and its installed components to become structurally reinforced. Light generated within or directed through the polycarbonate carries images/logos for displays, from these difficult roadways, driveways or walkways installation environments, for convenient and effective viewing by the public.

### PRIORITY/CROSS-REFERENCE TO RELATED APPLICATIONS

This application claims the benefit of U.S. Provisional Application No. 62/693430, filed Jul. 2, 2018 the disclosure of which is incorporated by reference.

### TECHNICAL FIELD

This invention relates generally to display panels. More specifically, this invention relates to lighted panels for display from roadways, driveways or walkways, for example. Yet more specifically, this invention relates to weather-resistant and crush-resistant lighted panels for display from roadways, driveways or walkways

### BACKGROUND

This invention relates generally to lighted display panels for roadways, driveways or walkways. To serve effectively and durably, these lighted panels must be weather-resistant and crush-resistant. Therefore this invention is related to the technical art of well-sealed, robustly constructed and sturdy electrical display panels.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The lighted display panel of this invention is tightly sealed within a polycarbonate enclosure. The interior of the enclosure, after the electro components described later are installed in it, is filled with polycarbonate (such as an epoxy) which sets up to become a hard, clear solid. This way, the installed electro components are sealed in and protected by the set-up polycarbonate. Also, this way light generated by the electro components may shine in and out of the enclosure. The enclosure may be any desired shape to enclose a desired volume. The perimeter of the enclosure may be, for example, exterior walls of panels made from durable plastic, polycarbonate, metal, glass or ceramic, or combinations of these materials. Also, the perimeter of the enclosure may be the outer surfaces of the same polycarbonate used to fill the enclosure after the electro components are installed in it. This way, for example, the enclosure may be made in a mold.

The enclosure is preferably sealed tightly. This way, the installed electro components are protected from the weather—heat, cold, sun, wind, dusty or dirty or polluted air, rain, snow, humidity, radiation, and shock or vibration, etc. This way, the enclosure is preferably weather-resistant.

Also, the enclosure is preferably reinforced—so the enclosure with the installed electro components are more protected from crushing from the weight of vehicles driving or passing over it, for example. Also, reinforcement of the enclosure may protect it from damage from the following:
shock, as when struck by a driven or fallen moving object;
vibration, as in the aftermath of shock, above; or from vibration through the medium where the enclosure is installed; or
fatigue, a longer-term effect of shock, vibration, cycling on-off weight loads, and/or cycling heat and cold changes, for example.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

One way to reinforce the enclosure is to surround it on the outside completely or partially with a durable metal or ceramic shell. Another way to reinforce the enclosure is to include struts or bracing on its outside or inside of metal or ceramic or polycarbonate, for example. The struts or bracing may be thickened regions or ribs of metal, ceramic or polycarbonate, for example. This way, the enclosure is preferably crush-resistant. The enclosure will typically be placed flat and horizontally in a roadbed. Typically, a top surface of the enclosure will be flush, or about flush in certain embodiments, with the surrounding roadbed top surface. The enclosure may be installed via a close friction fit or bolted or welded to under roadbed structure.

The enclosure of this invention may contain several electro (electric/electronic) components, including but not limited to, for example, singular or plural power supply, solar collection panel, battery, LED, light guide, back light, image/logo panel, transmitter, receiver, and controller micro board. The power supply preferably is integral of the enclosure, and self-sustaining. Solar collection panels and battery may enable the enclosure to be independent, and sustainably “off the-grid.”

Alternatively, if “the grid” is conveniently and effectively available, the enclosure may be hooked up to it, for example, as desired during periods of low demand and economical power availability, or as needed during periods when stored solar power, for example, is not available in desired amounts, or as a solar power backup, for example, to trickle charge battery storage. Light sources for the enclosure are also preferably integral, and when driven by battery storage, self-sustaining. LED's are preferred for direct and back lighting purposes. Preferably, LED's of changing or different colors are utilized. A light guide may be utilized to most effectively adapt internal light sources within the enclosure for the purposes of, for example, directing light through the logo film and out as a projected image through a top surface of the enclosure, or directing light to make sides or edges of the enclosure light up as a glowing display. This back lighting may be provided by a light source directly without use of a light guide, if location of the light source is convenient, without use of a light guide.

Preferably, the enclosure also contains an image/logo panel, including projector capabilities. This way, with or without the use of any light guide, a selected image may be projected from or shown on an outer surface of the enclosure. The image/logo panel may be as simple as a partially transparent film between an outer surface of the enclosure and a light source within the enclosure to provide a direct or reverse through-image. The transparent film may be fixed or changeable. If changeable, the film may be movable between a light source and an outer surface of the enclosure, as in a camera film roll being mechanically moved past a lens aperture. Also, to be changeable, a plurality of films may be fixed, but a light source changed relative to them, to create a change in image.

The image/logo panel may be utilized within the enclosure to create an image for projection through a top surface of the enclosure. Also, the image/logo panel may be as complex as a programmable LCD screen/system for still or even moving images being projected out through a top surface of the enclosure. Also, the enclosure may optionally contain a receiver/transmitter. This way, updated instructions, for example programming/code instructing adjustments in timing, type or brightness of display, may be sent from outside the enclosure and received by a logic controller board/system inside the enclosure. Also, this way, the enclosure may acknowledge receipt of the updated instructions, and may prepare, or send/transmit data for, reports that are relevant to the environment and operation of the enclosure, as well as being responsive to inquiries in the received instructions.

In an embodiment solar panels are positioned between the image to be displayed and the edge of the panel. Preferably the displayed image is provided on an LCD screen. A light guide is utilized to guide the light outward from the lighted pane. Alternatively external solar panels or other external power source can be utilized to power the display and/or an energy storage device, such as a battery or capacitor. A controller is provided for controlling the display of the LCD screen. Preferably the controller is configured to store images for display. In a preferred embodiment the controller is configured to communicate wirelessly to a secondary device. Preferably this wireless communication occurs via Bluetooth®. The lighted panel is configured to be placed in or on the surface of a roadways, driveways, walkways, or other outdoor substrate such as a patio.

In a preferred embodiment the controller is provided with an access port, such as a USB port, for connection to an external device for uploading of photos to the device. Alternatively, or in addition thereto, the controller can be configured for wireless upload of images from an external device. The controller can be configured to mirror an image shown on an external device via wired or wireless technology. A light guide can be used to direct light outward from the light panel. A light guide can be utilized to direct external light to an internal solar panel(s).

Furthermore, the enclosure may optionally contain various sensors to receive inputs from the environment and operation of the enclosure, as well as other inputs from human operators and other machines. Inputs from these sensors may be logged in, recorded, manipulated, and/or otherwise used by the micro controller to further enhance performance of the enclosure and panel. These sensors can be utilized, for example, to cause illumination of the lighted panel for low light times or to otherwise adjust the brightness of the display depending on the ambient light.

### BRIEF DESCRIPTION OF THE DRAWINGS

FIG. 1 is a top, schematic view of an embodiment of the present invention.

FIG. 2 is a front, cross-sectional view of FIG. 1 along the line “ - - - + FIG. 2” thereof.

FIG. 3 is a side, cross-sectional view of FIG. 1 along the line “ - - - + FIG. 3” thereof.

FIG. 4 is a bottom, schematic view of the embodiment depicted in FIG. 1.

FIG. 5 is an exploded view of FIG. 2.

FIG. 6 is a top view of an embodiment of the invention.

FIG. 7 is a top view of an embodiment of the invention.

FIG. 8 is a top view of an embodiment of the invention.

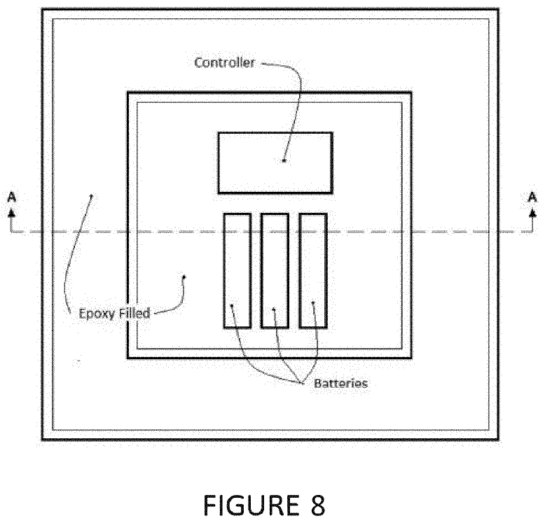

FIG. 9 is a cross sectional view along line A of FIG. 8.

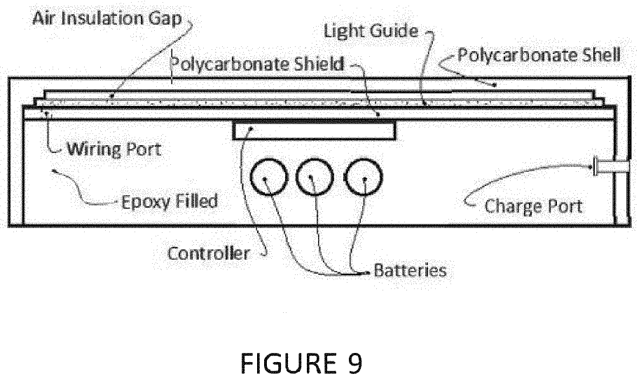

FIG. 10 is a top view of an embodiment of the invention having integrated solar panels.

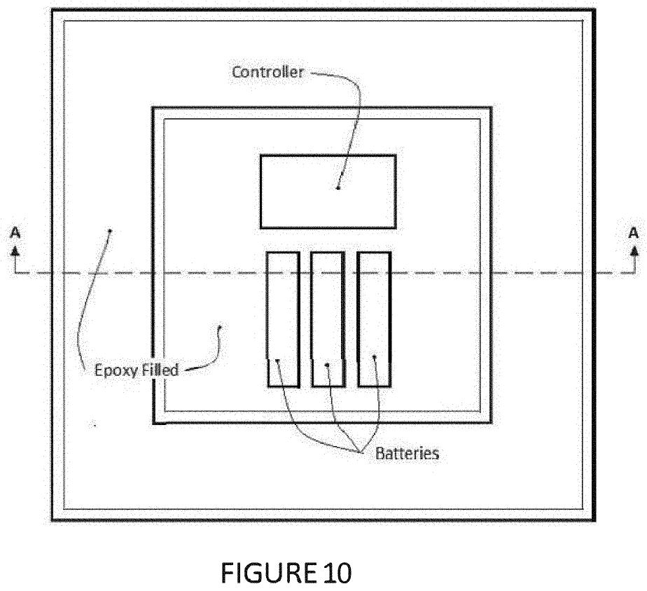

FIG. 11 is a cross sectional view along line A of FIG. 10.

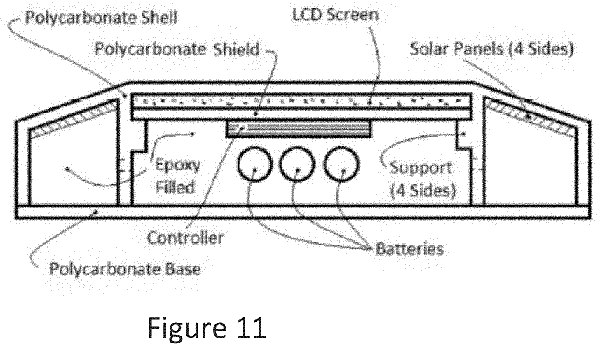

### DETAILED DESCRIPTION OF THE FIGURES

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

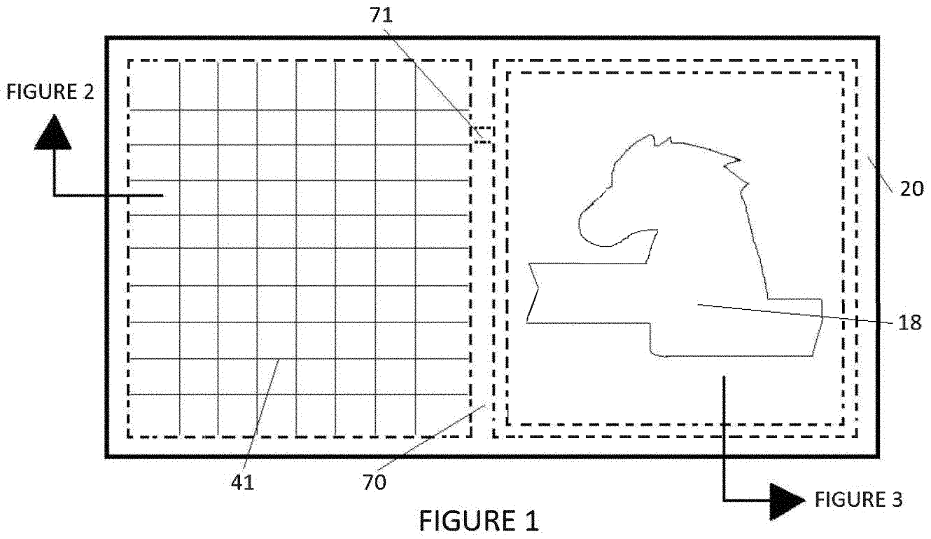

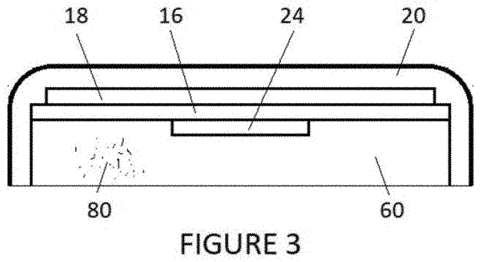

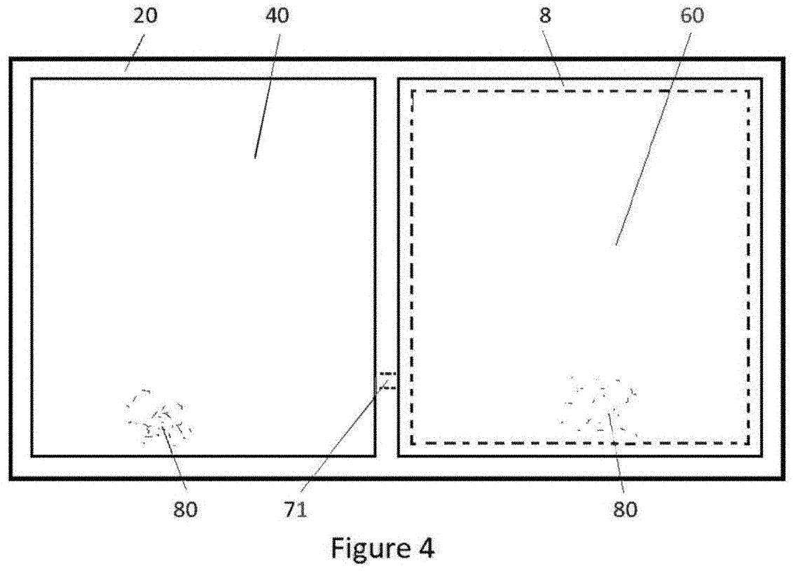

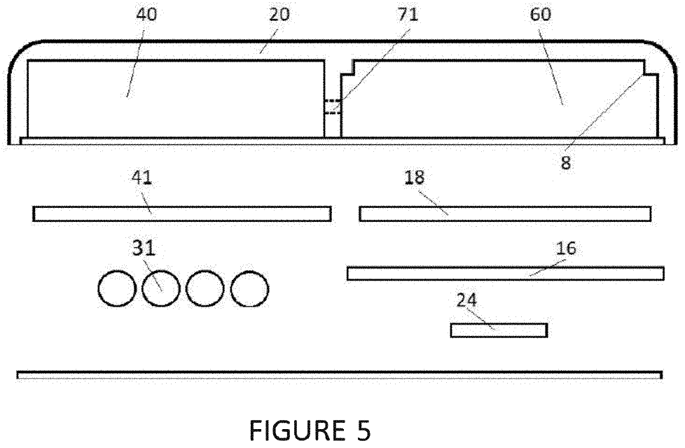

Referring to the FIGS. 1-5, there is shown one, but not the only, embodiment of the present invention. FIG. 1 is a top, schematic view of lighted panel 1, with displayed image/logo 18 through transparent polycarbonate cover 20. Polycarbonate base 22 acts to support cover 20 and close and seal display 1 and provide a bottom mounting surface therefore. Display 1 in this case is divided on the inside by internal divider 70 between the display side on the right, and solar panel 41 side on the left. Inside, wiring orifice 71 enables electrical connection by electrical wires or circuit lines among electro-components on different sides of internal divider 70.

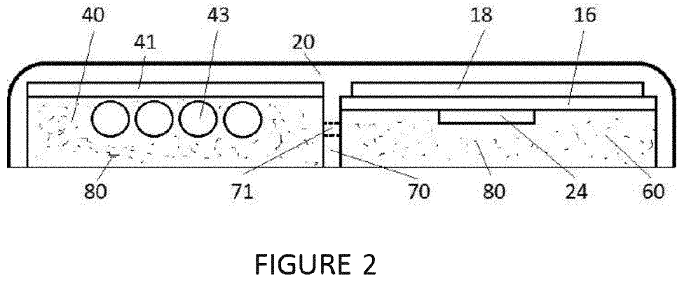

FIG. 2 is a front, cross-sectional view of FIG. 1 along the line “ - - - +FIG. 2” thereof, showing right side logo light guide cavity 60 with light guide 16, logo film 18 and micro-controller board 24. The left side boundary in this view of cavity 60 is internal divider 70 with wiring orifice 71 extending therefrom and leftward into power cavity 40. Power cavity 40, with batteries 31 and solar panel 41, receives sunlight energy through transparent polycarbonate cover 20, and stores it as electrical energy in batteries 31.

Both logo light guide cavity 60 and power cavity 40 are filled with epoxy or polymer fill 80 (polycarbonate). Light guide cavity 60 is filled with epoxy 80 on the right side up to the bottom of controller board 24 and light guide 16, the bottoms of which become a tight cap or lid on cavity 60 when epoxy 80 sets up. Likewise, power cavity 40 is filled with epoxy 80 on the left side in FIG. 2, up to the bottom of solar panel 41, which becomes a tight cap or lid on cavity 40 when epoxy 80 sets up.

Therefore, upon construction of display 1, internal divider 70, polycarbonate cover 20, base 22, and the two filled-up cavities, light guide cavity 60 and power cavity 40, plus the two tight caps of controller board 24 and light guide 16 in cavity 60, and the tight cap of solar panel 41 in cavity 40, all cooperate to make a reinforced, strong and sturdy enclosure as discussed above when epoxy 80 sets up in both cavities. This way, panel 1, when completed, can withstand compressive forces and stresses and fatigue, and not fail by crushing or otherwise disintegrating under the weight of cars, trucks or other vehicles or alternatively bicycles, pedestrians, or other items or travelers that are anticipated to place weight on the panel depending on where the panel is positioned. For example, a panel configured to be positioned in or on a roadway will be configured to be crushproof to withstand typical forces associated with a roadway. In contrast, a panel configured for positioning in a patio will not be required to be as strong to be considered “crushproof”.

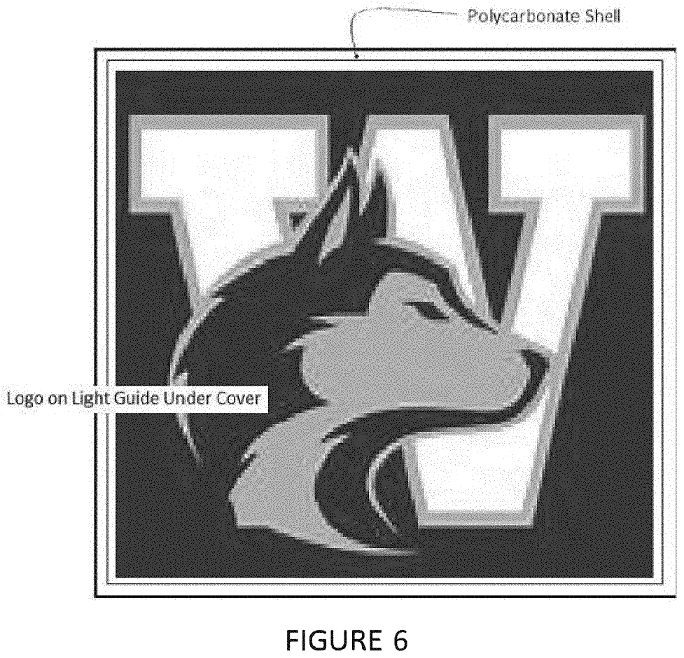

FIG. 6 illustrates an embodiment of the invention in which an image is displayed in a film, light guide or embedded in the cover of an embodiment of the invention. A light source is provided for emanating light from behind the image to provide an illuminated image.

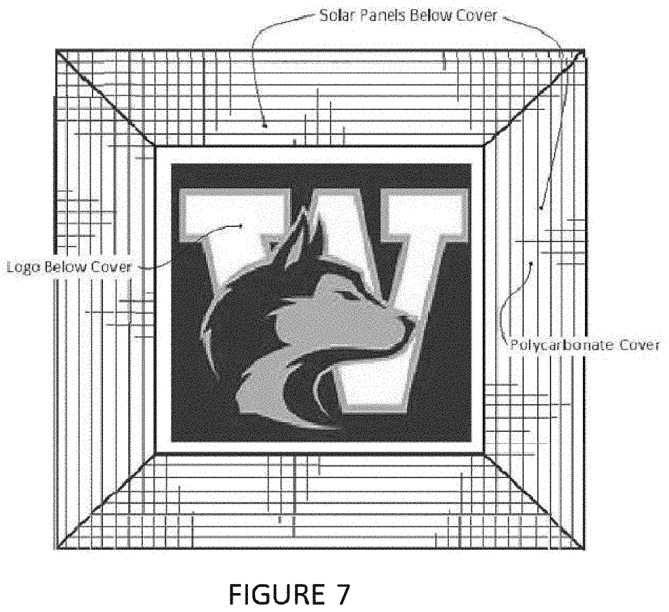

FIG. 7 illustrates an embodiment of the invention in which integrated solar panels are placed surrounding the image.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

I claim:

1. A crushproof, water resistant panel comprising:
a body, wherein said body is configured to be crushproof, wherein said body comprises a translucent top;
a display, wherein said display is configured to be displayed through said translucent top of said body, wherein said display is configured to provide a lighted display of an image;
an energy storage device configured to provide power to said lighted display;
wherein said body comprises a polycarbonate material filling said body.

2. The panel of claim 1, wherein said display comprises and image positioned beneath said translucent top and a light configured to emit light so as to illuminate said image.

3. The panel of claim 1, wherein said display comprises an electronic display.

4. The panel of claim 1, wherein said energy storage device comprises a battery.

5. The panel of claim 3, wherein said panel comprises a controller, wherein said controller is configured to control said electronic display.

6. The panel of claim 5, wherein said panel comprises a port configured to connect said controller to an external electronic device.

7. The panel of claim 5, wherein said controller is configured for wireless communication with an external electronic device.

8. The panel of claim 7, wherein said controller is configured for Bluetooth communication with an external electronic device.

9. The panel of claim 1, wherein said panel is configured for connection with an external solar energy collection device.

10. The panel of claim 1, wherein said panel comprises an internal solar energy collection device.

11. The panel of claim 5, wherein said controller is configured to store data, wherein said data comprises a plurality of images to display on said controller.

12. The panel of claim 11, wherein said controller is configured to cycle images from said memory to display on said display.

13. The panel of claim 5, wherein said controller is configured to display images from an external electronic device.

14. The panel of claim 1, wherein said panel is configured to be installed in or on the surface of a roadway.

15. The panel of claim 1, wherein said panel is configured to be installed in or on the surface of a patio.

16. The panel of claim 1, wherein said panel is configured to be installed in or on the surface of a pedestrian pathway.

17. The panel of claim 1, wherein said display is configured to display video.
